(19) United States
(12) Patent Application Publication
(10) Pub. No.: US 2003/0036356 A1
(43) Pub. Date: Feb. 20, 2003

(54) Wireless communication systems

(76) Inventors: Pita Witehira, Hamilton (NZ); Evan Lloyd Bydder, Hamilton (NZ)

Correspondence Address: Pita Witehira, Power Beat Int'l Ltd, Mystery Creek Airport Road RD2, Hamilton, 2010, NZ

(21) Appl. No.: 10/239,045

(22) PCT Filed: Mar. 20, 2001
(86) PCT No.: PCT/NZ01/00043

(51) Int. Cl. H04B 5/00; H04B 10/00; H04B 11/00

(52) U.S. Cl. 455/41; 379/56.1

(57) ABSTRACT

A free space data transfer system utilizing fibreless optical point to point and omni-directional transmission and reception arrays, and including data processors and organic elements capable of interactive multi-way video and modulated data transfer.

### TECHNICAL FIELD

This invention relates to methods of providing improved communications systems and particularly those based on free space wide-band wireless communications and information transfer including a free space data transfer system utilizing fibreless optical point to point and omni-directional transmission and reception arrays and including data processors and organic elements capable of interactive multi-way video and modulated data transfer.

### BACKGROUND ART

Communication in the present context relates to the use of electromagnetic, electronic and electrical systems for mutual transmission, reception and processing of data so that audio, video, analogue and digital information can be transferred, generally in real time, from one point to another.

Historically, the electrical transmission of information began with electric telegraph. It developed through audio bandwidths to video signals and from wire systems to guided wave and wireless electromagnetic wave transmission systems. With its present state of development, there is a growing desire for non-wired communication systems that have adequate bandwidth to communicate using a range of data forms from analogue or digital signals and with bandwidths encompassing audio signals to real-time video.

Remote inter-person real-time communication is currently carried out principally by audio bandwidth telephone systems. While some video facilities are used, these are mostly narrow bandwidth and provide poor quality transmissions. The quality of such video transmissions can be improved mainly by providing the users with greater bandwidth.

Alternative methods for providing a wide range of consumers, including business and domestic users, with adequate video bandwidth for inter-person real time video communication and the transmission of video data are either the use of high quality cables (coaxial cables or optical fibres) or microwave links. While cable systems are effective, and are used in areas of concentrated populations, their general use is relatively expensive. The cost arises because of the necessity to have each user in a cluster connected by a high quality cable to a local exchange or processing centre. Nevertheless there has been a rapid expansion of conducting and dielectric cable systems, including guided wave systems where wires are replaced by fibre optic cable. While these systems have been particularly effective for expanding long distance communications links, they are less suitable for short distance systems owing to the costs of laying or stringing cables, making connections to such cables, and the associated environmental and aesthetic concerns and costs from the installation and presence of these systems.

Microwave links are commonly used by commercial users for high density communications, but their use with domestic and business users and particularly clusters of uses has not been widely applied due to the cost and complexity. This may also be because no suitable management system for such networks has been developed.

Carrier frequencies for voice and high bandwidth wireless electronic communications can in principle be used over virtually the entire electromagnetic spectrum above about 100 kHz. As the bandwidth available in the free space electromagnetic propagation frequencies encompassing the frequency regions known as LF, MW, HF, VHF, UHF and microwave is limited, and has largely been allocated to existing users or systems, there is severe competition for the use of this limited bandwidth for communication and broadcasting applications. One effect of the limited bandwidth is that governments generally claim, own, regulate, sell and/or license bandwidth to certain users. Very often this results in a few wealthy persons, organisations or corporations having control of the right and opportunity to use the said bandwidth and in particular to broadcast TV and radio for public consumption. The resulting monopolistic control of broadcasting and telecommunications can result in the public paying excessively high prices for access to communications and broadcasts. Extensive work is being put into expanding the usable frequency range upwards, into the shorter microwave regions.

Two methods of providing high bandwidth are the use of optical fibres and the use of short wavelength microwaves. While each of these systems is effective and being further developed, the principal disadvantage is the cost. For example, it is currently estimated that the cost of installing fibre optics cable is around $US 300,000 per km. This cost limits the provision of high bandwidth communication systems to specialist users. It also essentially preserves the monopoly provided by the existing copper connections that link most private persons within most developed countries.

Ultra-wide bandwidths for communication systems can be achieved by using electromagnetic waves of very short wavelength. However the use of very short wavelengths requires line of sight communications links and the need for accurate alignment between sources and detectors. This in turn requires that detectors in particular are rigidly mounted to preserve the alignment, and makes it difficult to use detectors on non-rigid or movable platforms. It also requires that detectors need to be installed and aligned by skilled personal with specialist equipment.

Another disadvantage of most communications systems including wires, cables (including fibres) and microwaves is the environmental costs and disruption of installing them. Furthermore, as the number of desired users increases, it is often costly to add new subscribers to existing communication networks, especially in existing areas where demand increases beyond the facilities that were provided for the area.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a communication system embodying

a) at least one artificial ommatidia lens or refractive or superficially conducting cone and at least one photoplasmic rhabdomic structure or body sensitive and reactive to photon streams from a remote location;

b) a device including units of the above structure a) wherein one or more photon receptors are electronically responsive;

c) a device including elements of a) and b) above wherein the said structure is responsive to one or multiple wavelengths whereby one or more photoreceptors incorporated within said coupling relay information to one or more processors;

d) a first device including elements and means of a), b) and c) above whereby the said device is reactive to a second device at a location remote from the said first device by way of said photon stream;

e) a plurality of locations having at least one first device or at least one second device and with at least one location having one or more devices of the form of the first device and one or more devices of the form of the second device proximate and associated, and wherein said devices may interface with processors, amplifiers or communication channels.

According to another aspect of the present invention there is provided a communication system wherein

a) At least part of the communication channel within a cell uses free space propagation of electromagnetic waves from a source to one or more remote detectors;

b) Information or data is propagated by the modulation of the said electromagnetic wave by varying the properties of the source or of devices external to the source which interact with the said wave in accordance with the modulation requirements;

c) The free space transmission section uses directed electromagnetic waves to provide efficient use of transmitted power for the communication link;

d) One or more adjacent free space transmission paths may be used to provide path multiplicity to improve reliability and to counter signal losses from rain and/or other phenomena obscuring or attenuating the transmission path;

e) One or more free space transmission paths between any two or more mutually remote users may be equipped for bi-directional transmission and reception, with the communications and processing equipment at each of the path being designated hereafter as the “user”;

f) One or more of the transmitted beams may be divergent to reduce the accuracy of alignment required between transmitter and receiver, while one or more of the receiver or detector device polar diagrams may also be appropriately divergent to reduce the alignment tolerance of these components;

g) The electromagnetic spectral region used for the free space transmissions may include any frequency region, and may be appropriately narrow where necessary to minimise interference from other sources or solar radiation, and may include but not be limited to soft x-rays, ultraviolet light, visible light, near and far infrared light and microwaves, but with the preferred region being in the wavelength range from 300 to 30,000 nanometres;

h) The transmitted beam may be multiplicated in one or more wave frequencies, or one or more paths or one or more geometries, or any combination of these, thereby being able to simultaneously transmit the same data with multiplicated frequencies, paths and/or geometries.

i) The free space communication paths between users may, where appropriate, be clustered in cells whereby one or more users within a cell maintains one or more line of sight communications channels with at least one other user in the cell. Each said cell may consist of two or more users. Groups of 2 or more cells may be connected by high bandwidth communications means to form “supercells” which may in turn be grouped to form hypercells, with an extending hierarchy of cells, supercell, hypercells and superior cells to develop an encompassing network which may ultimately provide an extensive communication system. The users within a cell may have radial-style connections to the communication centre for the cell, or may be daisy-chained in series to form a sequence culminating in a communications centre for the cell, or there may be a mixture of such connection systems.

j) One or more users in each cell may be operated as a communication centre for communications with a corresponding communications centre in at least one other cell, either by guided wave (wired) or free space (wireless) communications means, so that every cell has a direct communications link to at least one other cell within a group of users and all cells are thereby directly or indirectly connected with each other by communications means. This in turn applies to supercells, hypercells and to the general hierarchy of cell systems.

k) One or more communications centres within each cell network may additionally or alternatively be connected either directly or via some or all of the hierarchy of cell systems to other communications systems such as the public subscriber telephone network (PSTN) or other regional, national or international networks to provide reciprocal access between the cell systems and some other communications systems.

According to a further aspect of the present invention there is provided a communication system wherein:

a) The communication system is divided into cells;

b) Each cell has two or more levels or hierarchies within the said cell;

c) Communications between users within each cell are provided by duplex generation and subsequent detection and amplification of modulated photon streams in the wavelength range 300 to 30,000 nanometres;

d) The first hierarchy of users may include a sub-set of users each having a modulable source and detector-amplifier providing duplex line-of-sight communication with one or more other users in the same level or hierarchy in the cell wherein the bandwidth of the system is at least equal to the that required for two audio (or one duplex audio) channels. Each source and detector-amplifier within this subset provides facilities for electronic communications to and from each user. Power for operation the system is provided by the user:

e) The lowest (first) level or hierarchy in the cell is a sub-set of users each having modulable sources and detector-amplifiers which can provide duplex line-of-sight communication with at least one user in the next level of hierarchy within the cell wherein the said next level of hierarchy functions as a communications switching system or “exchange” for its first level users, with power for operating each user's system in each level being provided by that user.

f) The second level in the hierarchy may not only have of line-of-sight sources and detector-amplifiers communicating with each user (either directly or indirectly) of the lowest hierarchy, but may also have means of communication with an equivalent hierarchy in one or more other cells such that each communication to and from the lowest hierarchy in one cell may passes though the second level of that cell to the second level of another cell and onto a second user at the lowest level in the said second cell. The sources and detector-amplifiers both for communication within and between cells would generally have bandwidth of adequate size so that that it can provide simultaneous communications for a significant number of users in each cell. In this sense, the linked second levels of the hierarchy of each cell collectively form a “supercell”. The said supercells may be linked directly to other communications systems, or to a hypercell centre, and so on as required over the hierarchy.

g) One or more of the second hierarchy levels in selected cells are provided with communications links with a third level forming a “hypercell” equivalent to a regional switching centre or regional exchange, which provides an interface with other communications systems such as other telephone system and other video systems, whether via wire, cables, optical, fibres or wireless (including microwave) systems.

According to an additional aspect of the present invention there is provided a communication system wherein

a) A first device which includes at least one display, said display being modulated or manipulated at high speed in accordance with information provided to said display;

b) at least one second device remote from the said first device and including sensors and processing reactive to the display of the said first device; and

c) at least one device or system incorporating functions of a) and b) above and being capable of processing, reproducing or disseminating data or information from the said modulation or manipulation displayed by any said first or second device.

According to yet another aspect of the present invention there is provided a communication system including

a) a first device for producing, modulating or manipulating one or more patterns or waves from a first source wherein the said first device imparts information readable by at least one second device; and

b) one or more second devices for concentrating, amplifying, reflecting, repeating, re-transmitting, demodulating or otherwise processing the said patterns or waves to obtain or transfer the said information from the first source to one or more users; and

c) one or more switching systems, devices or processor which route and/or convert information from said first devices for processing by selected said second devices in accordance with identification or address codes or other identification means with or preceding the information allowing the said second devices to process and or output the said address and data through another first device in a sequence which results in the transfer of the said information from the source to the users whose addresses or identifications were encoded or included with the information from the first source; or

d) one or more switching systems, devices or processors which route and or convert one or more types of information through a pre-arranged sequence of first and second devices and or other communications means as appropriate wherein the said information can be accessed by one or more users of the system according to their preferences.

According to another aspect of the present invention there is provided a detection system for one or more simultaneous communication links using modulated free space photon streams in the wavelength range 300 to 30,000 nanometres wherein part of the transmitted streams are intercepted and focused or concentrated onto an array of one or more detectors wherein

a) the array is continuously or intermittently, or otherwise as appropriate, scanned to determine which detectors are receiving signals from the distant source beams, what the signal levels in the said detectors are, and to distinguish between separate streams from different sources which are simultaneously concentrated, focused or projected onto different elements of the said array, and

b) the information obtained by scanning the array may be used or applied to ensure that amplifiers are appropriately connected to detectors or groups of detectors which are receiving dominant signal levels from each of the incident photon streams and whereby if the focused or concentrated patterns representative of the streams move over the array, the amplifier inputs are switched to different detectors to follow the said pattern maxima to allow the amplification of the signals associated with the maxima of each of the incident patterns as movement occurs.

According to one aspect of the present invention there is provided a source of electromagnetic radiation emitting at wavelengths shorter than 1 mm, which effectively travels in straight lines, wherein

a) the radiation is produced by an electric current flowing in a gas, semiconductor or electrically responsive material;

b) the radiation is modulated by either controlling the flow of electricity in the said gas or semiconductor or material, or by controlling one or more properties of a medium interposed between the radiation source and any intended receivers of the radiation by means of electrical, magnetic or optical signals;

c) the modulation imparts information to the transmitted radiation such that images, sound or data can be reconstructed at a distant point by detecting the variations in the pattern or radiation from the said source at the said distant point;

d) one or more channels of data, information or signals may be transmitted by multiplexing the electrical signal used to produce the modulation, or by using a spatial modulation of two or more radiators with separable characteristics, or any combination of each; and

e) the radiation is capable of being collected, detected, and processed at points distant from the source to allow a usable reconstruction of the modulation signal for the purpose of using, displaying, storing or otherwise manipulating the original signals, data or information.

The present invention includes the use of organic elements such as conductive optical lenses, organic photo-receptors sensitive to light whereby such organic elements are interactive electronically with microprocessors and voltage modulators.

Said organic elements also being capable of culture design through cell growth and application.

Such cultured elements may include organic semiconductor cells, light transmitters and optical arrays.

In yet another aspect of the present invention there is provided for a free space data transfer system including one or more organic optical elements.

In a further aspect of the invention there is provided for a free space data transfer system having one or more omni-directional organic optical elements.

In yet a further aspect of the invention there is provided for a free space data transfer system having one or more artificially cultured organic optical elements.

In another aspect of the invention there is provided for a free space data transfer system having one or more artificially cultured omni-directional organic optical elements.

In yet a further aspect of the invention there is provided for a free space data transfer system having one or more optical elements, one or more optical diffuser elements, one or more electronic receptor elements, one or more data processing elements, the said elements being capable of organic production.

Another aspect of the invention provides for a free space data transfer system having one or more optical elements, one or more optical diffuser elements, one or more electronic receptor elements, one or more data processing elements, and/or one or more signal modulator elements, the said elements being capable of organic production.

In yet a further aspect of the invention there is provided for an omni-directional free space data transfer system having a compound transmitter array and a compound receiver array.

In a further aspect of the invention there is provided for an omni-directional free space data transfer system having at least one artificial ommatidia lens or refractive or superficially conducting cone and at least one photoplasmic rhabdomic structure or body sensitive and reactive to photon streams from a remote location.

Reference throughout this specification will now be made to the present invention as applying to signals, voice, data and video, henceforth called “information”, for communications, information transfer, data transfer and control, henceforth called “communications”. However, it should be appreciated by those skilled in the art that other types of signals and modulations may be used in conjunction with the invention, not necessarily being for communications, information or control purposes.

The system described herein may be used for communications with both narrow and wide bandwidth requirements, including multiple video bandwidths. It may also be used for direct and relayed communications, including communications between earth bases and satellites, or between earth bases via satellites.

According to this invention, at least part of the communication channel uses modulation of free space line-of-sight propagation of ultra-short wavelength photon streams in order to avoid the cost and limitations of wires or fibres. Users who are connected with the photon stream system to another user would commonly use a narrow beam bi-directional photon transmission system in which a high frequency carrier wave is imposed to support the modulation of information on the stream. The use of ultra-short wave photons permits compact highly directional steams to be used which minimises the source power required. In this context “ultra-short wave” includes microwave, infrared, visible, ultraviolet and soft Xray propagation, but for most practical purposes, the useful range is 300 to 30,000 nanometres. The transmitted photons need not be coherent.

Also in the context of this invention, “line of sight” means one or more straight sections of path which are unobscured by sold objects and through which one or more relatively narrow electromagnetic wave photon streams can be steered or passed by means of lenses, mirrors, prisms, diffractors or other technologies to make an electromagnetic waves connection between at least one source and at least one detector-amplifier.

Path multiplicity may be used to improve reliability. The path may be multiplexed in frequency, wavelength, geometry or space, or in several of these diverse multiplicities. With ultra-short wavelength streams the losses and scattering from rain, dust and small flying objects such as leaves, birds, insects and the like become a potential problem. By using more than one path for the signal transmission, spaced so that there is a low probability of every path being obscured at the same time, (such as by a large bird) the likelihood of maintaining continuous signal transmission is greatly increased. This result can be obtained by using at least one modulated source with a modestly divergent stream intercepted by 2 or more physically separated detector-amplifiers, by 2 or more separate modulated sources intercepted by at least one detector-amplifier with a moderately divergent polar diagram, or by a combination of such devices. Both sources and detectors have to be accurately aligned within their respective polar angles to feed or receive optimum signal levels. This may be assisted by the use of tracking devices with feedback which steer detectors so that the optimum signal is achieved. By using bi-directional duplex systems, the source and detector for given user may be coupled so that the source is automatically aligned by being kept parallel to the detector, with the latter being aligned according to maximum received signal.

In some preferred embodiments of this invention, the communication or broadcasting systems described herein are optimised by the use of elements or devices to direct, collimate, concentrate or focus photon streams at either or both of the source and the detector-amplifier locations, or at other positions where the photon stream needs to be redirected. The said elements or devices may comprise or include lenses, reflectors, refractors, diffractors, waveguides or dielectric or conducting structures. They may include inorganic or organic materials, and may in certain cases embody or consist of organic materials that are grown, cultured or artificially manufactured. Such materials may be solid, liquid or gases, or combinations of these, may be flexible or rigid, and may be controllable partially or wholly by means of electric fields or currents within their intended range of operation.

The electromagnetic spectral region used for the free space transmissions may employ any frequency region with ultra-short wavelengths for which both the source and the detector-amplifier are compact and relatively economical. Thus it is not necessary to use coherent wave systems. A narrow spectral region with high signal bandwidth is preferable, and therefore this requires microwave, infrared, visible or higher frequencies. However where visible or ultraviolet frequencies are use, there may be problems of interference with daylight and direct solar radiation in particular. It may be preferable to use waves within the infrared spectrum where the solar radiation components are very small. Alternatively, relatively sharp cut off optical filters together with directional, narrow band transmitters and receivers may be used to limit solar radiation interference, particularly in the visible region.

The used of ultra-short wavelengths including infrared and visible electromagnetic waves allows the use of compact low-cost modulable sources and detector-amplifier systems with a very high (video) bandwidth. As a result, each communication link with each user may readily be of high bandwidth to accommodate video as well as audio bandwidth signals. One or more users in each cell can be equipped to accommodate the bandwidth of a multiplicity of users comprising the cell and thereby be a communication centre for that cell, providing communications with one or more other cells to form a supercell group with other cells. Where users are not suitable for grouping radially to a single communications centre for a cell, different users may be “daisy-chained” as appropriate in series whereby a series of users with increasing bandwidth act as 2-way relays or repeaters for other users, linking them in turn to a group communications centre which further communicates with other cell communications centres to form a “supercell”. A combination of radial and series connections may be used, with each successive serial connection requiring a higher bandwidth to accommodate a greater rate of 2 way information interchange. However due allowance may be made for a low probability of all users requiring maximum bandwidth at the same time, thus reducing the total bandwidth required in the system. Additionally account may be taken of the fact that users are unlikely to operate video transmissions simultaneously in both directions, again allowing for a reduction in the total bandwidth that needs to be provided.

The present invention may be used for one-way or two-way communication with satellites and between mobile and or fixed earth based stations. It may be used for providing both temporary and permanent communication links. The present invention is able to provide both exceptionally high bandwidth and freedom from interference. The invention is suitable for data, information, video, TV, radio, telephone, data, voice, fax, Internet and all other communication protocols including multi-channel cable or pay TV and free-to-air video and audio broadcasts.

The invention provides a secure system which is not readily intercepted by unauthorised users. It provides no danger or risk to people, animals or vegetation and presents minimum environmental pollution. It is a low power system which is generally of low cost to install and operate. Typically the small amount of power required to operate the system would be provided largely by users linked to the system. The present invention is also suitable and cost-effective for use with applications such as households which may require a high speed (wide bandwidth) forward but slow (low bandwidth) return of data, such as for TV inputs.

A significant benefit of the present invention is that no regulatory authority licensing would be required for the setting up or use of the invention. Furthermore, the present invention can readily be made in a portable form which would allow temporary communication links or intercepts to be provided for events, emergencies and other applications.

The invention is particularly suitable for networking a diversity of home users, buildings, businesses and the like with high bandwidth and mulitplicated ports at far less cost than other media, such as copper, coaxial cable, fibre and microwave, to any backbone communications network.

The present invention can readily be configured with repeaters, re-directors, amplifiers and includes the use of omni-directional compound arrays to work around and within buildings and/or other obstacles and thus used for a highly localised communication system or communication interface as well as for general communication networks. It can also be relatively cheaply installed and used in inaccessible areas by the installation of compact low power self-contained repeaters which may generally also include amplification or regeneration.

The modulation system of the present invention may include means to convert input signals such as sound, light, physical values, codes, characters, symbols and the like into electrical signals, and then from said electrical signals into a modulated wave or pattern. The type of modulation used may vary according to the nature of the input signal and the purposes for which the data is used, and may vary from amplitude modulation to frequency modulation to pulse code modulation, or be any other type of modulation as appropriate. In many applications, this modulation would be imposed on a high frequency sub-carrier wave which can provide high bandwidth while being many orders of magnitude lower in frequency than that of the photon stream. The modulation may be imposed by means of varying the power, voltage or current or other signals feeding into the source used for the pattern. Alternatively, the modulation may be imposed by altering physical properties by electrical means, whether directly or indirectly, such as transmittance, reflectance, orientation, polarisation, scattering, absorption or other properties, of either a source medium or of a medium or device placed external to a source and which interacts with the photon stream from the said source to provide the required pattern. In some embodiments of the invention, the modulation may be achieved or assisted by the use of one or more organic elements or devices. Such elements or devices may comprise cultured or grown or artificially manufactured substances, which may be solid, liquid or gaseous or some combination of these phases. Modulation systems may include organic or inorganic material that are responsive to electric currents or electric fields.

The source used to provide the required pattern may itself use emissions of light, infrared, microwave or other radiation processes such as in lasers, semiconductor diodes, semiconductor devices, electrical arcs, electrical discharges, materials heated to high temperatures, ionic or atomic or molecular transitions, or the reflection or application of emissions from other artificial or natural devices. Sources may be directed, focused or paralleled by means of curved mirrors, lenses, apertures, Fresnel devices or other means as appropriate. The sources maybe split or divided physically or by polarisation, by partially reflecting or refracting systems or other means to provide a multiplicity of arrays or to generate a multiplicity of patterns or directions. The power for the system may be generated locally or remotely, or by means of photovoltaic cells or other independent sources and/or stored in batteries or capacitors for use as required.

The data patterns may be generated or augmented by external manipulation or modulation, if required, by means of optical switching, including by means of electro-optical or magneto-optical devices in conjunction with, if necessary, active or passive devices such as polarisers, which change their transmittance, reflectance or refractance by altering the polarisation of the radiation appearing at or passing through them. Kerr and Pockels cells are examples of such electro-optical devices.

Such devices respond, directly or indirectly, to varying input voltages or currents to alter their properties. Alternatively, electro-chromatic, magneto-chromic or opto-chromatic effects may be used with suitable devices to modulate the source intensity or chromaticity. Reflectance or refractance can be altered by piezoelectric or magnetostrictive effects and thereby used to modulate the direction, intensity or other properties of the photon stream in one or more particular directions. Another method which could be used for changing the polarisation are nematic, cholesteric or smectic or liquid crystals which respond to electric fields, or plasma or other media which change polarisation of light in response to magnetic fields by virtue of the Faraday effect.

Additional methods of source modulation include the use of birefringence or dichroic media or non-linear crystal or amorphous media whose properties may be modulated electrically, by electric or magnetic fields, by electromagnetic waves, or by other means.

Alternatively, modulation patterns may be produced by electronically controlled variable mirrors, such as a matrix of small or microscopic mirrors that are illuminated and which in effect act as pixels generating, sending and or switching a pattern in one or more directions.

In other instances, the radiative or transmissive properties of materials used to form or modulate the pattern may be changed by electro-mechanical forces, by mechanical movements, by temperature effects, by application of electromagnetic radiation or by other means.

The radiated or emitted data may be displayed in one or more well-defined directions by means of splitters, refractors, diffractors, mirrors, prisms, lens or such devices which may serve to concentrate or project the greatest part of the source energy in narrow paths oriented with associated second device detector units wherein the said second devices are generally remote from the source pattern.

Each pattern displayed may comprise one or more subsidiary patterns, that is it may be in space, time or composition, a combination, mixture, array, sequence or assembly of several dependent or independent source patterns. For example, a composite source pattern may be generated by an array of proximate lasers or light emitting diodes or electrical discharge sources of different wavelengths oriented to one or more remote second devices. Each sub-pattern may be differently modulated to carry a different set of data, or to duplicate data. Sources may include visible or invisible light sources to aid with alignment, while the data may be sent by proximate infrared or otherwise invisible or poorly visible sources. There may be one or more different lenses, mirrors, beam splitters, deflecting, mixing or focusing devices for different sources within a single composite pattern as defined above.

In general, the source data streams may be multiplexed in one or more different methods including space, time, frequency or form. Such multiplexing methods can include a multiplicity of sources, or a multiplicity of carrier or source wavelengths or frequencies, a multiplicity of modulation media, or a multiplicity of source or modulation frequencies. There may be time division or frequency division multiplexing to expand the channel capacity. There may also be a multiplicity of separate sources or patterns and a corresponding multiplicity of detectors to form a spatial multiplexing or redundancy of the said pattern(s).

In general the data path is a straight line, or series of straight lines, wherein changes of direction may be made by means of reflectors, refractors, lenses, prisms and/or by detecting, amplifying and re-transmitting the data. At each such junction, the pattern may be divided and sent in a multiplicity of new directions or re-oriented in a multiplicity of directions. There may be provided at each junction, bend or at any suitable point, devices for deflecting or amplifying or regenerating the pattern, or for creating a multiplicity of routes for any such data patterns.

In general, a source may have a multiplicity of components including lenses, mirrors apertures and arrays or distributions of emitters which allows it to interact with one or more detector-amplifiers, and similarly a detector device may have a multiplicity of components including lenses, mirrors, apertures, arrays and distributions of cells, elements or pixels which allows it to interact with one or more sources. Furthermore, detector-amplifier systems may generally incorporate or be associated with sources or emitter components in order to form part of a system which can result in the provision of a series of links within a communication network.

Often the sources of the modulated photon streams would be highly collimated in one or more geometries and therefore there may be a need to facilitate or automate the alignment between sources and remote detector-amplifiers. The use of corner reflectors and in particular, accurately ground prism corner reflectors, allows radiation to be returned accurately in the direction from which it came. Thus corner reflectors can be placed adjacent to detector-amplifiers and used to return images to the associated source for alignment of the said source with the said detector-amplifier. By using an array of sensors and a suitable simple feedback control system, the alignment of a source can be automatically maintained. In a like manner, a detector-amplifier may have an array of photon sensors at a selected image point which detects an image from either a modulated source or a separate alignment source adjacent to the modulated source. Sensors placed within or near the detector-amplifier may be used to detect displacements of the image of the source placed at the modulator and by manual means or by using feedback control, alignment of the detector-amplifier can be obtained and maintained. Liquid or artificial lenses may be used for which the focal plane can be automatically controlled by manipulating properties of the lens device.

The concentration and amplification of the pattern for detection, demodulation, diversion, address analysis, display, reproduction or re-radiation may be accomplished in the first instance by means of a wide aperture focusing system which concentrates the interaction between the first and second devices into an array or a small area which can be directly or indirectly or by means of wave guides, detectors, amplifiers, photon multipliers or image intensifiers applied to a photon or electric field sensitive device for conversion into an electrical signal. Typically there may be an array of one or more such components for intercepting a multiplicity of patterns.

In one embodiment of the invention, the concentrator may use a convex dielectric or artificial lens or concave mirror with a means to detect the concentrated image at the focal plane, or to transport the corresponding energy stream in an array of waveguides or fibres to one or more detectors or photon receptors. The concentrator may use detectors and suitable control mechanisms whereby alignment and of focusing is automatically corrected and maintained within suitable limits to ensure optimum use of energy, patterns, space, time and associated devices. Detectors may include or interface with photo-receptive organic materials, elements or devices. Such elements or devices may include receptors, filters, waveguides or processing structures that are cultured, grown or artificially manufactured, or which may include organic materials or devices produced by the said means.

Alternatively, some or all of the detectors can be replaced by image intensifiers, photomultipliers, wave amplifiers or equivalent devices. When the pattern is a composite of two or more displays, or for other purposes, the concentrated images at the focal plane can be addressed to two or more detectors, or fed by an array of fibres, waveguides, mirrors, beam splitters, prisms, lenses or other transport means to a multiplicity of detectors with different characteristics whereby they are sensitive respectively to the separate components of a composite pattern. For example, different wavelength characteristics may be determined by use of interference filters, dichroic or disperse media, gratings, holographic devices, wave filters, refractors, non-linear wave mixing or other means as appropriate.

Following detection, the separated components of the patterns may be amplified in suitable wideband low-noise amplifiers, and have their addresses decoded or demodulated if appropriate. Then according to the type of data and the purposes for which it is intended, the data is re-routed through one or more successive pattern forming systems in the locality of the said detectors and displayed to other sites, and or demodulated and made available for access to the current site.

Alternatively, if the local site contains an interface with another communications system or common backbone network, it may be used to bring signals from the other communications system or backbone network into the system of the present invention, or to take signals from the present system into the other communications network or backbone system. Thus certain local sites in the present system may be used as interfaces, exchanges or hubs with other networks and communications systems to create a globally accessible data transfer network.

Groups of local sites configured in accordance with the present invention may also be linked together to form one or more self contained cells, with at least one member of each cell connecting to and from a backbone communications network or other communication means which links to other cells and other communications systems. The backbone network for the present system may itself use in part or completely, additional similar communications systems as embodied in the present invention, and thus a very large area can be linked by such systems at a reasonably low cost.

The communication system may be used for one-way or two-way wide band data transfer. A significant application of the present invention is to provide broadcasts displayable or reproducible as audio, TV or wideband TV and/or video coverage. These broadcasts may then be accessed by any authorised or capable user within the network or in range of the broadcast. They may be directed over any selected solid angles, or be made omnidirectional as required.

While for network communications the power required for the operation of the first device units of the invention is low, of the order of a few Watts, the applied power can be much larger when used to disseminate TV and other broadcasts independently of other communicant networks, or as a separate communication system. The use of high source power would provide the system of this invention with a higher range and allows a greater divergence of displayed source pattern to allow a multiplicity of users to interact with particular first devices which may be customised for such applications.

In order to provide a better quality and more general communications service, in one aspect of the invention the network may access one or more redundant paths so that displays containing data can generally be accessed by or from any user by two or more alternative paths. This may result in at least two classes of user systems. One system would be for users who are “sole” users and who interact with a cell centre or hub which links to a communications backbone. These users would not be involved in acting as relays for other communications, and would require simpler processing equipment, and would need to handle less bandwidth. However one or more second classes of users would provide communications relay or transfer services, whereby they receive data from one source and pass it on to one or more other users or processors. Such second class of users may also interact with the system to receive or transmit their own data. For these services, the second class of users are provided with equipment of greater processing power and potentially wider bandwidth channels to accommodate a series of users. Each such user may include equipment that processes, decodes, addresses and routes data accordingly.

A beam of ultra-short wavelength radiation or light (including infrared) from a distant source can easily be concentrated or focused by a reflecting, diffracting or refracting device onto a small area at the focal plane of the device. Beams from diverse distant sources may be directed onto different small regions of the focal plane of the device and can readily be distinguished from each other much as an astronomical telescope projects the images of stars discretely onto its focal plane. As the direction of the axis of the focusing device shifts, the position of the images of distant beams or sources on the focal plane shifts. Therefore the invention allows for the intensity or any pattern of the image of the distant source to be monitored by arranging for detectors on the focal plane to move to maintain alignment with the sources. Alternatively, as proposed in this invention, the detectors can be fixed, such that by using a multiplicity of detectors, the source image may be transferred from one detector to another as the axis of the focusing device shifts.

With such an array of detectors, the invention provide for the array to be scanned to determine which detectors are receiving signals from the source beams, that is which detectors have the sources imaged onto them at any given time, and also to switch the output of the said detector to the input of the amplifiers which process the signals being detectors from the said sources.

Generally two or more separate sources being imaged on the array at the focal plane of the device may be distinguished by the absence of high level signals on detectors in the array which are between detectors registering high levels signals. By scanning the array at a sufficiently high rate, as the axis of the focusing device moves, the scanning system can identify the movement step by step, and thus maintain identification of each image according to its particular source, and thereby continue to feed signals detected from given source into the same amplifier as the source image moves over the array.

The array of detectors may consist of an array of discrete photodiodes or other photon detectors physically at the focal plane of the focusing device. Alternatively, it may consist of a suitable semiconductor matrix, photon detecting material, waveguide or other system which can be scanned or swept. As an example, charge coupled device (CCD) photon detecting arrays may be placed on the focal plane to find and detect the source images and their patterns as they are scanned. Where it is not practical or preferable to have the detection array at the focal plane, imaging systems or fibre optics light guides may be used to transfer the light pattern to a suitable detection array placed elsewhere.

This invention may be applied to broadcast signals reproducible as audio or TV or the like while avoiding control by regulatory authorities. It may also be used for providing a multiplicity of fixed or portable communications channels in audio, high speed data or video formats, for replacing telephone, coaxial, microwave or optical fibre links, and for extending the range, multiplicity or versatility of communications systems.

When used to provide the equivalent of TV or sound broadcasts to a large number of customers, the radiation source may be a high intensity solid, gaseous or semiconductor electromagnetic radiation emitting device or a gaseous electrical arc or discharge device such as high efficiency sodium or mercury vapour lamp or other arc discharge in a vapour or gas, or any process where radiation is emitted as a consequence of electronic flow, wherein the current, voltage or power supplied to the said radiation source is modulated directly, or alternatively the source photon stream is modulated subsequent to emission, by one or more source using digital or analogue means. The invention may also be applied to light sources where the gaseous electric currents are produced by way of induction or the application of microwaves to excite or maintain a discharge.

The nature of the modulation applied is to enable the transfer of audio or video signals or data or information to receivers with appropriately sensitive radiation collectors and/or detector-amplifiers aimed at or otherwise responsive to the radiation source. The source may be directed into a limited solid angle by the use of suitable reflectors, diffractors, lenses, refractors or shields, or it may be expanded to radiate over a full 360 degree circular or over a suitable spherical pattern. The modulated radiation may be coded or scrambled to prevent unauthorised users from receiving or decoding the information contained therein. The signals may be multiplexed so that one or more channels may be transmitted from the same source or from the vicinity of the same source.

For example, using this invention a video supplier may choose to simultaneously transmit a range of videos over different channels through the same or adjacent modulated sources by spatial, temporal or other multiplexing, to allow customers to view these without having to personally collect or play the corresponding tapes or disks. Customers who are authorised receivers of the supplier would have descrambling codes or circuits that enable them to select and view the videos. Similarly the system may be used to radiate or broadcast a multiplicity of entertainment, data streams, voice channels, or other material which authorised users may receive and descramble as authorised or required.

In a preferred embodiment of the invention, customers would detect the signals they require with a line-of-sight collimating system concentrating radiation onto a radiation detector diode and/or amplifier, which feeds into detecting, demodulation and amplifying circuitry as required for display of the signals in a TV, audio or display or recording system. The receiving system may also be configured, where required, so that it would only operate when the customer had paid their account or purchased a suitable code or key, or updated the same, or used other means to make any required payments.

When used for a two way communication channel, each end of the channel in the line of sight would incorporate at least one radiator and at least one detector, so that reciprocal simultaneous transmission and reception could be implemented. Non-linear paths may be converted to equivalent line of sight paths by the use of one or more reflectors, refractors or repeaters suitably placed to ensure that the transmitted waves can eventually be intercepted by a detector at the opposite end of the communication link.

### BRIEF DESCRIPTION OF DRAWINGS

Further aspects of the present invention will become apparent from the following description which is given by way of example only and with reference to the accompanying drawings in which:

FIG. 1 indicates a compound light receptor of the present invention.

FIG. 2 is a diagrammatic view of a part of a spatially diverse multiple pattern communication system in accordance with one embodiment of the present invention.

FIG. 3 is a diagrammatic view of a part of an alternative spatially diverse multiple pattern communication system in accordance with one embodiment of the present invention.

FIG. 4 is a diagrammatic view of a simple radial cellular network in accordance with one embodiment of the present invention.

FIG. 5 is a diagrammatic view of a combined serial and radial network in accordance with one embodiment of the present invention.

FIG. 6 is a diagrammatic view of a 2-way device in accordance with one embodiment of the present invention

FIG. 7 is a repeater amplifier of the present invention.

FIG. 8 is a display and amplifier unit of the present invention.

### BEST MODES FOR CARRYING OUT THE INVENTION

A system as described herein may be initiated by duplicating existing hard wired local telephone networks with an ultra-short wavelength line-of sight wireless system while offering additional bandwidth to accommodate other desirable features. The system can be made distributed, that is to be reliant on a multiplicity of users having both a source and detector-amplifier that can relay other users' communications through a cell network. This allows s system to be configured without a complex major central controller (analogous to a telephone exchange). This method would also allow for redundancy with multiple paths.

An appropriate method is to modulate a suitable spectral region where there is potentially appropriate bandwidth, for example in the infrared region which is essentially immune to daylight effects. Modulable ultra-short wave sources and detector-amplifier systems such as in the infrared and visible spectral regions may be made to be compact, low power, and low cost devices which can provide wide band line of sight communication. These can be used to provide a wide bandwidth and a low noise or error rate. The efficiency may be further improved for many applications by utilising the ability of these systems to be highly directional. This spectrum may be provided with suitable bandwidth, such as of the order of 1-500 MHz to allow for video coverage and for providing a series of daisy-chained users. Each user would be able to function with a low power (˜1W) source and detector-amplifier systems and a suitable interface and software. A cell of customers could be developed so that each is within range of at least one other user within the cell. Communication cells may be developed to typically contain between 10 and 1000 users. Each cell may also contain a master controller/communications centre which interfaces with other cells and has an interface with either a supercell or hypercell or equivalent hierarchy system or with a conventional telephone system provider and with suitable TV, radio and other one way entertainment providers. Users within the system would be allocated a unique code number, equivalent to a universal telephone number. This would allow communications passing through the channel to be intercepted by the correct user. However, general purpose uni-directional transmissions such as for TV programs can be selected by a multiplicity of users.

The system may operate by each individual user being enabled to communicate with at least one other similar system via multiplicated directional 2-way ultra-short wave communications links within the cell until it either reaches the customer being sought (if they are within the cell) or reaches the master controller/communication centre which would route it to the correct cell or telephone system or information or entertainment source. Essentially each transmission link is a short range line-of-sight link with a typical maximum range of around 10 km. The system would be suitable for fixed but not mobile installations, as each device would need to be aligned with the nearest suitable other user to achieve the best signal with the minimal power use and low cost. Information may be passed from one source/detector-amplifier pair user to the next user allocated within the various lines of sight. Each successive user system knows from the associated code number which next user to pass it onto. Thus the whole network with each cell is readily linked by a succession of source/detector-amplifier pairs. In other words, each pair may operate as a minor telephone exchange for the cell.

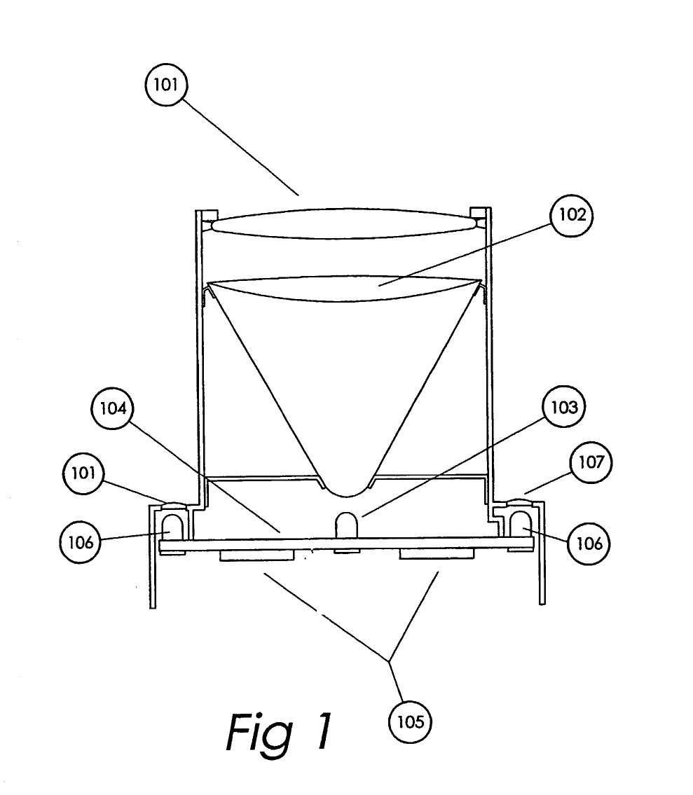

FIG. 1 indicates a part compound light receptor of the present invention whereby 101 is a lens structure, 102 is a crystalline cone device whereby said device directs relevant photons from a distant display to photoreceptor 108, which is coupled to circuit board 104 which includes processors 105. In one aspect of the present invention circuit board 104 may include display diodes 106 behind amplifier lens 107.

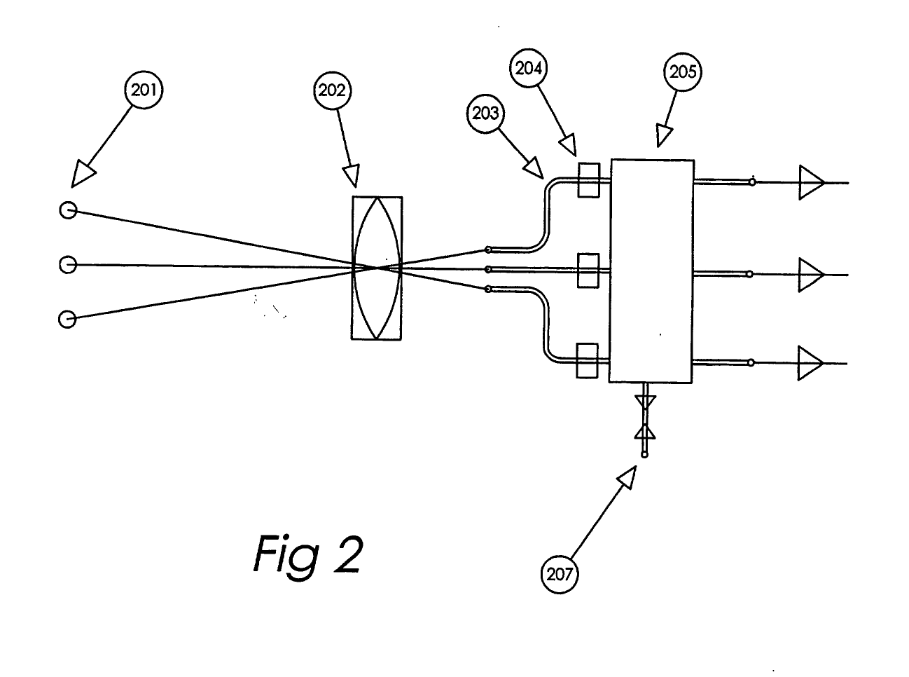

FIG. 2 illustrates a set of spatially diverse sources 201 emitting near parallel or collimated patterns into the direction of a broad area collector 202 which concentrates energy packets or streams from the respective sources 201 onto corresponding waveguides 203 which feed detectors 204. The output of the detectors is fed into a processor 205 which decodes the associated addresses and routes the associated patterns as appropriate into new sources 206 for transfer to additional detectors and processors, while providing a local input/output port 207.

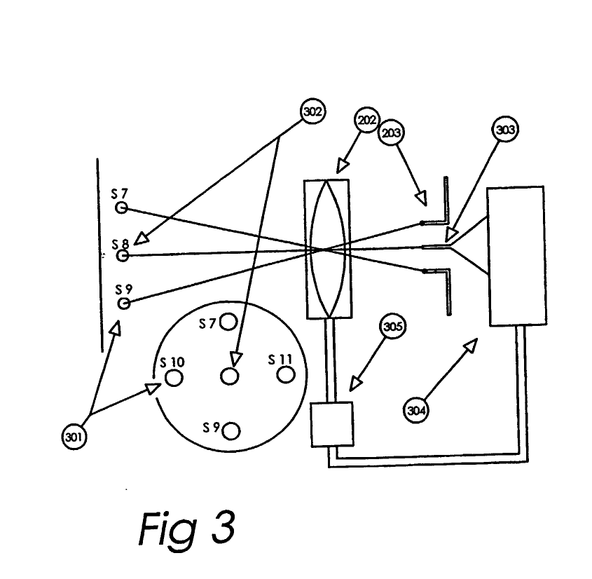

FIG. 3 shows a set of spatially diverse data sources 301 associated with a central alignment source 302. After concentration by 202, the modulated patterns are fed through waveguides or fibres 203 for processing. However the energy from the alignment source 302 is fed into an array of waveguides or fibres 303 which feed by means of a separate set of detectors 304 into a controller 305 whose output is used to maintain accurate alignment of the concentrator with respect to the alignment source 302.

FIG. 4 shows a cellular communications system connected to a backbone network 401. The cell hub 402 is connected to the backbone network 401 and feeds an array of send/receive systems 403 which are respectively aligned with corresponding send/receive systems located at the sites of the system's users. In some cases, where line-of-sight is unavailable, one or more deflectors, reflectors or repeaters 404 are used to create a series of paths linking the user 405 to the hub 402 via send/receive units 403.

FIG. 5 shows a more complex radial/serial cellular network in which a hub 402 is connected to a communications backbone 401. The hub 402 provided for single users 405 through send/receive systems 402 and also multiple or series users 404 through send/receive systems 501. Multiple or serial users 404 connect to one or made additional users 502 or 402 so as to form a serial network through which data can pass to different users within the network, or to and from the backbone network 401.

More generally, an imaging system can be used to concentrate patterns from a multiplicity of diverse first devices, wherein corresponding detectors can be placed in the focal plane of the imaging system but separate from each other, each reactive to a specific image from a separate specific first device. Consequently a multiplicity of patterns can be detected and processed with the use, at a given site, of a concentrator as part of a second device.

FIG. 6 is a diagram of a 2-way device generally indicated by 601. Data from one or more distant patterns is modulated in energy streams which is concentrated by refractor 602 and displayed on area 603 which allows detectors (not shown) to respond to the energy streams and to process or demodulate the said patterns. Divergent patterns modulated by or from devices in area 604 or auxiliary sources in area 604 are collimated by refractor 605 to ensure a defined narrow pattern suitable for a distant detection system. A partially reflecting dielectric 606 images the distant detector via refractor 605 onto a screen 607 which can be examined, with magnification if necessary, and which may contain alignment marks, and which as a result can be used to align the collimations of both the detector area 603 and the source pattern 604 with the said distant patterns.

FIG. 7 is a repeater amplifier of the present invention whereby 701 is a permanent static, fixed or mobile stand. 702 is a control housing. 703 is a rotatable table, 704 a lens, 705 a display light, 706 is a directional photovoltaic cell. Said cell provides charging power, said lens includes communication multi-way photo-optics and connections to processors and amplifiers.

FIG. 8 is a display and amplifier unit of the present invention whereby 801 is an alternative amplifier unit of the present invention, 802 is an up-facing photovoltaic cell array, 803 is a display window/lens combination of which there are multiples in a 360° circle. 804 is a street light post and 805 is an attached conventional street light. In operation part of the present invention in the format illustrated by FIG. 8 allows households within sight of the street lamp to download data from the active display windows of said amplifier, unit 801 which is electrically powered via photocell 802 which converts photon streams from the sunlight and street lamps to store power for electronic circuits and processors of the amplifier 801. Said amplifier units 801 being optically communicative with other remote or distant units of like abilities, thus providing alternative networking of amplifier units of the present invention between and with households, businesses and backbone telecommunications centres.

In a preferred embodiment of the invention where it is used for broadcasting TV or radio equivalent signals without requiring regulatory approval, a suitable omni-directional high intensity modulable radiation source may be generated by one or more semiconductors, light emitting devices, gaseous electrical discharge sources or other suitable means. These sources may be modulated at by varying the voltage, current or power or signal applied to the material or electrical discharge in accordance with the modulating signal. Alternatively modulation may be imposed by varying the properties of absorbers, reflectors, polarisers, scatterers or the like by way of the modulating signal The photon stream may be either digitally or analogue modulated, according to the type of signal required to be transmitted. Suitable amplifiers, power supplies and electronic switching devices may be used to drive and modulate the electrical current or the discharge voltage applied to the material or gaseous discharge. The sources may be placed on suitable elevated positions, poles or towers within any city or town area or region, or in suitable positions to feed one or more towns or cities in order to ensure that most residents had line of sight access to the sources

The invention may be applied to arrays or distributions of sources whether or not they are also used to provide visible lighting to allow customers or users to download information or to communicate, including in inside or outside of buildings, office blocks, dwellings and both urban and rural areas. Systems embodying the invention may be used to transfer or pass on information or data in a “daisy chain” fashion by radiating information by means of modulation of the output or radiation which is detected at or near subsequent sources then used to modulate the said additional sources. Information may also be provided by arrays of sources where the required modulation is produced within the detector by combining the signals detected from different sources within the said array.

In other applications sources and/or detector-amplifiers for broadcasting or communication may be placed on vehicles, including aircraft, airships, or balloons to position or elevate them suitably to access large numbers of users. In such cases, the receiving units may include self-aligning servos or controls which would enable them to track moving radiation sources, such as when sources are attached to aircraft.

In another aspect of the invention, public illumination devices, such as one or more sources used for area lighting or street lighting systems may be modulated in accordance with the invention to provide broadcasts of data, information or entertainment, or used for infrastructure (such as mounting, power supply and the like). When used for communication purposes, these installations may be configured for a multiplicity of 2-way data transfer, and operate, for example in place of other links such as telephone cable, coaxial cable, microwave links or optical fibres. For broadcasting applications, the said installations may be configured to radiate modulated waves for TV or other entertainment or information programs. Thus all manner of lighting systems, both public and private, may be applied in accordance with this invention to provide broadcasts or for communications purposes to households, facilities and organisations generally without requiring licensing or regulatory approvals, and generally by appropriate modifications of existing arrays. Thus street lighting itself, or systems associated with or operating as street and area lighting, may also be used in accordance with the invention for communication and broadcasting.

Similarly, lighting within buildings may be used a communications means or broadcasting system for data, information or entertainment. The invention may generally be used to provide communications and data transfer between or within areas, buildings, stadiums, houses, populated areas and the like. In addition, the invention may be used for communication and data transfer to or from vehicles and between vehicles.

In other embodiments of the invention, radiation sources and radiation detectors may be used as part of more general communication or broadcasting systems which may also incorporate other methods of data or information transfer, such as microwave radiation, radio waves, fibres, wires, coaxial cables or other systems.

In another embodiment of the invention, modulated radiating sources may be used to provide location information, control or guidance for vehicles and other devices. For example, the approach lights for guiding aircraft to airports and for assisting their landing can be modulated to additionally transmit information to detectors on the aircraft which operate one of more of the aircraft controls to improve the efficiency and reliability of automatic landings. Similar systems can be used to guide and control ships coming into ports or navigating coastal waters, and for many related purposes.

In operating the invention for communications or broadcasting, the simplicity of the collimating or focusing systems required with the invention allow the use of simple plastic lenses, prisms and the like, plastic moulded reflectors and generally low cost commercial quality components. Thus the communications, broadcasting and receiving systems described herein need be neither costly nor highly sophisticated. The system of the invention are therefore low cost and simple to install. The system is tolerant of vibration and misalignment and is simple to set up. The systems can easily be repaired or realigned after mishaps or problems, even as a result of natural disasters such as earthquakes, storms, tornadoes and the like.

The communication system of the invention allows the use of repeaters, relays and simple multiplier or divider networks to amplify, diver, join, develop a communications hierarchy or otherwise provide both small and large communication systems at a low cost per user. The systems can add new customers or users at a very low cost and can readily join with new sources and tours, and into alternative networks such as the PSTN. It can readily be put into relatively inaccessible areas where it can be powered from low power sources such as solar cells with battery backup.

The system can readily be made essentially immune from interception, and is therefore a secure method of communications. There are not biological environmental or pollution effects as a result of installing or using this system. It does not cause visual pollution.

Aspects of the present invention have been described by way of example only and it should be appreciated that modifications and additions may be made thereto without departing from the scope thereof.

1. A free space data transfer system including one or more organic optical elements.

2. A free space data transfer system having one or more omni-directional organic optical elements.

3. A free space data transfer system having one or more artificially cultured organic optical elements.

4. A free space data transfer system having one or more artificially cultured omni-directional organic optical elements.

5. A free space data transfer system having one or more optical elements, one or more optical diffuser elements, one or more electronic receptor elements, one or more data processing elements, the said elements being capable of organic production.

6. A free space data transfer system having one or more optical elements, one or more optical diffuser elements, one or more electronic receptor elements, one or more data processing elements, and/or one or more signal modulator elements, the said elements being capable of organic production.

7. An omni-directional free space data transfer system having a compound transmitter array and a compound receiver array.

8. An omni-directional free space data transfer system having at least one artificial ommatidia lens or refractive or superficially conducting cone and at least one photoplasmic rhabdomic structure or body sensitive and reactive to photon streams from a remote location.

9. A device including units of the above structure of claim 8 wherein one or more photon receptors are electronically responsive.

10. A device including elements of claims 8 and 9 above wherein the said structure is responsive to one or multiple wavelengths whereby one or more photoreceptors incorporated within said coupling relay information to one or more processors.

11. A first device including elements and means of 8, 9 and 10 above whereby the said device is reactive to a second device at a location remote from the said first device by way of said photon stream.

12. A plurality of locations having at least one first device or at least one second device and with at least one location having one or more devices of the form of the first device and one or more devices of the form of the second device proximate and associated, and wherein said devices may interface with processors, amplifiers or communication channels.

13. The transmission of information by means of modulation of short wavelength electromagnetic waves of between 300 and 30,000 nanometres propagating in free space wherein the waves need not be coherent waves.

14. The use of one ore more reflecting, refracting or diffracting devices with one or more sources of short wavelength modulated electromagnetic waves which need not be coherent and which can be used separately or collectively to provide one or more beams of photons of controlled angular width in one or more selected directions to provide a controllable projection of information to remote detection systems.

15. The use of the system of claims 1 and 2 in order to provide an ultra-wide-band communications link.

16. The use of one or more reflecting or refracting or diffracting devices to concentrate electromagnetic waves or photons on to an array of one of more photon detectors to provide sensitivity over a controlled angular region to short wavelength modulated waves in order to permit or enhance the detection, amplification and decoding of the information contained therein.

17. The use of modulation of current, voltage or power applied to short wavelength electromagnetic wave sources in the wavelength range of 300 to 30,000 nanometres to impose information on the photon stream provided by the source such that the information can be decoded by detectors and amplifiers remote from the source.

18. The modulation of current, voltage or power applied to gaseous electrical discharges in order to vary the intensity of the short wavelength emissions in the range 300 to 30,000 nanometres in accordance with the modulation for providing a projection of information which can be accessed by remote detection systems.

19. The modulation of current, voltage or power applied to one or more electromagnetic radiation sources in the wavelength range 300 to 30,000 nanometres by way of amplitude modulation to provide a projection of information which can be accessed by remote detection systems

20. The modulation of current, voltage or power applied to one or more electromagnetic radiation sources in the wavelength range 300 to 30,000 nanometres by way of intensity modulation to provide a projection of information which can be accessed by remote detection systems

21. The modulation of current, voltage or power applied to one or more electromagnetic radiation sources in the wavelength range 300 to 30,000 nanometres by way of frequency modulation to provide a projection of information which can be accessed by remote detection systems

22. The modulation of current, voltage or power applied to one or more electromagnetic radiation sources in the wavelength range 300 to 30,000 nanometres by way of pulse width, pulse amplitude, or pulse position modulation to provide a projection of information which can be accessed by remote detection systems

23. The modulation of current, voltage or power applied to one or more electromagnetic radiation sources in the wavelength range 300 to 30,000 nanometres by way of pulse code modulation to provide a projection of information which can be accessed by remote detection systems

24. The modulation of current, voltage or power applied to one or more electromagnetic radiation sources in the wavelength range 300 to 30,000 nanometres by way of packets of data to provide a projection of information which can be accessed by remote detection systems.

25. The modulation of streams of photons emitted by sources in the wavelength range 300 to 30,000 nanometres for transmitting information by varying the flux in one or more directions by means of selective transmission, absorption, reflection, refraction, diffraction, displacement, polarisation, scattering or other means that is external to the creation of the photons, in accordance with the modulation signal.

26. The use of one or more short wavelength sources and one or more corresponding remote detectors and amplifiers in the wavelength range 300 to 30,000 nanometres wherein the photon stream is modulated by direct or indirect means with one or more carrier waves which are in turn able to be frequency, phase, amplitude, single side band, pulse, pulse code or otherwise modulated and, if appropriate, multiplexed, to transfer information to the said detector systems.

27. The provision of communication channels as stand alone system, or as part of more general communication systems by way of controlled beam width modulated sources and corresponding remote detectors, amplifiers and demodulators which operate in the wavelength range 300 to 30,000 nanometres.

28. The use of arrays of photon detectors, with or without the use of photon concentrating devices, to enable detection and decoding of modulated beams in the wavelength range of 300 to 30,000 nanometres without any need for precise alignment of the detector system or its housing.

29. The use of modulated short wavelength sources in the range of 300 to 30,000 nanometres for public or private broadcasting of information equivalent to television, programs, radio programs or data streams for use with computers, radios, televisions or other display or reproduction devices.

30. The use of photon detection and demodulation systems within the wavelength range 300 to 30,000 nanometres to interface to television sets, video displays, radios or computers to enable them to reproduce programs data or information broadcast by means of the modulation of corresponding remote short wavelength sources.

31. The use of street-lamp structures, electric power poles and pylons, street poles, building fixings and the like as mounting supports and to assist with the provision of power to either or both of arrays of one or more modulated short wavelength sources in the range 300 to 30,000 nanometres and arrays of one or more detecting and amplifying systems for the said wavelengths in order to provide communications or broadcasting links which interface with dwellings, buildings or service requirements in the vicinity of said arrays.

32. The use of one or more portable or semi-portable modulated sources in the wavelength range of 300 to 30,000 nanometres with one or more corresponding portable, semi-portable or fixed detectors and amplifiers remote from the sources to broadcast, communicate with or transfer data or information from the said sources to said detectors.

33. The use of arrays of photon detectors in association with one or more photon concentrating devices to provide a controlled detection angle for receiving, amplifying and decoding modulated photon streams in the wavelength range of 300 to 30,000 nanometres.

34. The use of spatially broad photon detecting devices in association with one or more photon concentrating devices to provide a controlled detection angle for receiving, amplifying and decoding modulated photon streams in the wavelength range of 300 to 30,000 nanometres.

35. The use of arrays of photon detectors in association with one or more photon concentrating devices together with a scanning system to select and lock on to those of the said detectors which provide the maximum, or alternatively adequate or optimal, levels of desired signal for receiving, amplifying and decoding modulated photon streams in the wavelength range of 300 to 30,000 nanometres.

36. The use of automatic gain control systems in detection amplifiers for signals decoded from remote modulated sources in the wavelength range 300 to 30,000 nanometres to alleviate amplifier overload or distortion in the decoded or demodulated information, while still being able to detect very low level signals where necessary.

37. The use of reflection, refraction, diffraction or scattering devices or surfaces to change the direction of one or more projected modulated streams of photons, or to alter the divergence or convergence of one or more streams of photons at any position along a path in order to steer, concentrate, diverge or otherwise adjust the shape, direction or intensity of the beam in order to improve its efficacy as a method of transferring information from one place to another.

38. The use of modulated sources and corresponding remote detectors and amplifiers in the wavelength range 300 to 30,000 nanometres to transfer data to or from a stationary point to a moving point on an object such as a vehicle, ship or aircraft, in order to provide communications, data or control functions to or from the said moving object.

39. The use of one or more modulated sources in the wavelength range 300 to 30,000 nanometres and one or more corresponding remote detectors and amplifiers to provide a communications link from one terminal point to another terminal point wherein at least one said terminal point is linked to other communications systems which may use sources and detectors in the same wavelength range, or which may comprise any other sort of communication link in any other wavelength range, and which may function as free space transmission, guided wave transmission or wire transmission systems.

40. A method for transferring information from a point to one or more remote points by means of one or more modulated streams of photons in the wavelength range 300 to 30,000 nanometres in which multiplexing can be achieved by separately modulating adjacent or superimposed photon streams where the streams or information contents can be distinguished at the remote points by the use of address codes, different polarisation, different wavelengths, different modulation frequencies, different packets of information, different directions of projection, or other means as appropriate.

41. A method for transferring information from a point to one or more remote points by means of modulated streams of photons in the wavelength range 300 to 30,000 nanometres in which two or more streams are transmitted along different paths to provide a spatial diversity in order to enhance the reliability of the information transfer.

42. A system of communication or broadcasting using modulated free space wave propagation in the wavelength range 300 to 30,000 nanometres which has the property that, due to the ubiquity of natural and artificial radiation in this wavelength range and the freedom from interference due to the line-of-sight propagation and the control of the angle of emission that can easily be achieved, precludes the need for control or licensing of this region of spectrum for use in broadcasting or communications, and which can therefore escape the control or monopolisation imposed on other broadcasting and communication systems.

43. The use of one or more arrays of parallel directed sources for the projection of modulated streams of photons in the wavelength range 300 to 30,000 nanometres which can be operated with each array of sources in parallel to provide a higher photon intensity in each desired direction that would be possible with a single source.

44. The use of one or more arrays of parallel directed sources for the projection of modulated streams of photons in the wavelength range 300 to 30,000 nanometres which can be operated with different sources in each array operating at different wavelengths, different modulation frequencies, or different polarisation's in order to provide a diversity of multiplexed streams which can be separated by relatively simple means by detectors remote from the source in order to separate, identify and process the different sets of information being transmitted.

45. A method of multiplexing communications by providing photon streams with photons of different wavelengths modulated with different information

46. A method of multiplexing communications by providing photon streams with different properties such as polarisation, spatial path, wavelength, modulation frequency or the like, modulated with different information.
